(19) United States
(12) Patent Application Publication
(10) Pub. No.: US 2022/0009454 A1
(43) Pub. Date: Jan. 13, 2022

(54) NOZZLE UNIT

(71) Applicant: TOYOTA JIDOSHA KABUSHIKI KAISHA, Toyota-shi (JP)

(72) Inventors: Ryousuke ARIYOSHI, Kariya-shi (JP); Kazuhiko HARAGUCHI, Kariya-shi (JP); Kenichiro ISEKI, Kariya-shi (JP)

(73) Assignee: TOYOTA JIDOSHA KABUSHIKI KAISHA, Toyota-shi (JP)

(21) Appl. No.: 17/365,218

(22) Filed: Jul. 1, 2021

(30) Foreign Application Priority Data
Jul. 13, 2020 (JP) 2020-120157

(51) Int. Cl. B60S 1/52

(52) U.S. Cl. CPC B60S 1/52

(57) ABSTRACT

A nozzle unit is configured to spray washer fluid to a windshield of a vehicle. The nozzle unit may include a base plate and a washer nozzle protruding upward from an upper surface of the base plate. The base plate may include a thin portion provided around the washer nozzle and a thick portion provided around the thin portion and having a thickness greater than a thickness of the thin portion.

### CROSS-REFERENCE TO RELATED APPLICATION

This application claims priority to Japanese Patent Application No. 2020-120157 filed on Jul. 13, 2020, the contents of which are hereby incorporated by reference into the present application.

### TECHNICAL FIELD

The technique disclosed herein relates to a nozzle unit configured to spray washer fluid to a windshield of a vehicle.

### BACKGROUND

Nozzle units configured to spray washer fluid to a windshield of a vehicle are known. For example, Japanese Patent Application Publication No. 2018-165079 describes such a nozzle unit in which a washer nozzle is disposed on an upper surface of a cowl top panel. There are also nozzle units in which a washer nozzle is disposed on an upper surface of a hood of a vehicle. As above, in general nozzle units, a washer nozzle is disposed on an upper surface of basement plate (such as a cowl top panel, a hood panel, etc.; such a plate will be termed a base plate hereinbelow).

### SUMMARY

Since a washer nozzle protrudes upward from a base plate, a pedestrian (e.g., his/her head) may collide with the washer nozzle when he/she collides with a front potion of the vehicle. The disclosure herein proposes a technique that enables a reduction in an impact applied from a washer nozzle to a pedestrian.

A nozzle unit disclosed herein is configured to spray washer fluid to a windshield of a vehicle. The nozzle unit may comprise a base plate and a washer nozzle protruding upward from an upper surface of the base plate. The base plate may comprise: a thin portion provided around the washer nozzle; and a thick portion provided around the thin portion and having a thickness greater than a thickness of the thin portion.

With this nozzle unit, when a pedestrian collides with the washer nozzle, the base plate thereby bends or fractures at the thin portion around the washer nozzle. As a result, the washer nozzle is buried into the base plate, thereby reducing an impact applied from the washer nozzle to the pedestrian.

### BRIEF DESCRIPTION OF DRAWINGS

FIG. 1 is a perspective view of a front portion of a vehicle 10.

FIG. 2 is a cross-sectional view of a nozzle unit (along a line II-II in FIG. 4).

FIG. 3 is a cross-sectional view of the nozzle unit along a different line from that of FIG. 2 (along a line III-III in FIG. 4).

FIG. 4 is a top plan view of a boss.

FIG. 5 is a cross-sectional view of a front side plate.

FIG. 6 is a front plan view of the boss.

FIG. 7 is a cross-sectional view of a rear side plate.

FIG. 8 is a graph showing acceleration applied to an impact site upon a collision with a washer nozzle.

FIG. 9 is a top plan view of a boss according to a first variant.

FIG. 10 is atop plan view of a boss according to a second variant.

### DETAILED DESCRIPTION

Some of the features characteristic to the nozzle unit disclosed herein will be listed. It should be noted that the respective technical elements are independent of one another, and are useful solely or in combinations.

In an example of the nozzle unit disclosed herein, the thin portion may comprise a plurality of line portions extending radially from the washer nozzle.

This configuration facilitates the washer nozzle to be buried into the base plate.

In an example of the nozzle unit disclosed herein, the thin portion may comprise a loop portion surrounding the washer nozzle.

This configuration facilitates the washer nozzle to be buried into the base plate.

In an example of the nozzle unit disclosed herein, a groove may be provided in a lower surface of the base plate within the thin portion.

The thin portion can be formed in the base plate by the groove being provided in the lower surface of the base plate. If the groove is provided in an upper surface of the base plate, foreign matter is likely to accumulate in the groove. Adhesion of foreign matter to the upper surface of the base plate can be curtailed by providing the groove in the lower surface of the base plate.

In an example of the nozzle unit disclosed herein, the nozzle unit may further comprise: a cover covering a cowl portion which is a portion between a hood of the vehicle and the windshield; and a boss protruding upward from an upper surface of the cover. The boss may comprise an upper plate including an upper surface of the boss and a side plate extending downward from the upper plate. The base plate may be the upper plate.

This configuration enables the washer nozzle to be disposed at a higher position relative to the cover, thereby allowing the washer nozzle to spray the washer fluid to the windshield suitably.

In an example of the nozzle unit disclosed herein, the side plate may comprise a thin portion extending along a width direction of the vehicle; and a thick portion adjoining the thin portion of the side plate and having a thickness greater than a thickness of the thin portion of the side plate.

With this configuration, the side plate of the boss bends or fractures when the washer nozzle collides with a pedestrian. As a result, the boss is compressed, and thus the boss can absorb an impact applied from the washer nozzle to the pedestrian.

In an example of the nozzle unit disclosed herein, the thin portion of the side plate may extend linearly along the width direction.

This configuration facilitates the side plate to bend or fracture, thereby allowing the boss to absorb the impact suitably.

In an example of the nozzle unit disclosed herein, the thin portion of the side plate may comprise a plurality of thin portions arranged at intervals along a vertical direction.

This configuration enables the boss to be compressed at different positions, thereby allowing the boss to absorb the impact suitably.

In an example of the nozzle unit disclosed herein, a groove may be provided in an inner surface of the side plate within the thin portion of the side plate.

The thin portion can be formed in the side plate by the groove being provided in the inner surface of the side plate. If the groove is provided in an outer surface of the side plate, foreign matter is likely to accumulate in the groove. Adhesion of foreign matter to the outer surface of the side plate can be curtailed by providing the groove in the inner surface of the side plate.

In an example of the nozzle unit disclosed herein, a thickness of the side plate may continuously decrease from the thick portion of the side plate to the thin portion of the side plate.

This configuration enables the boss to absorb the impact suitably.

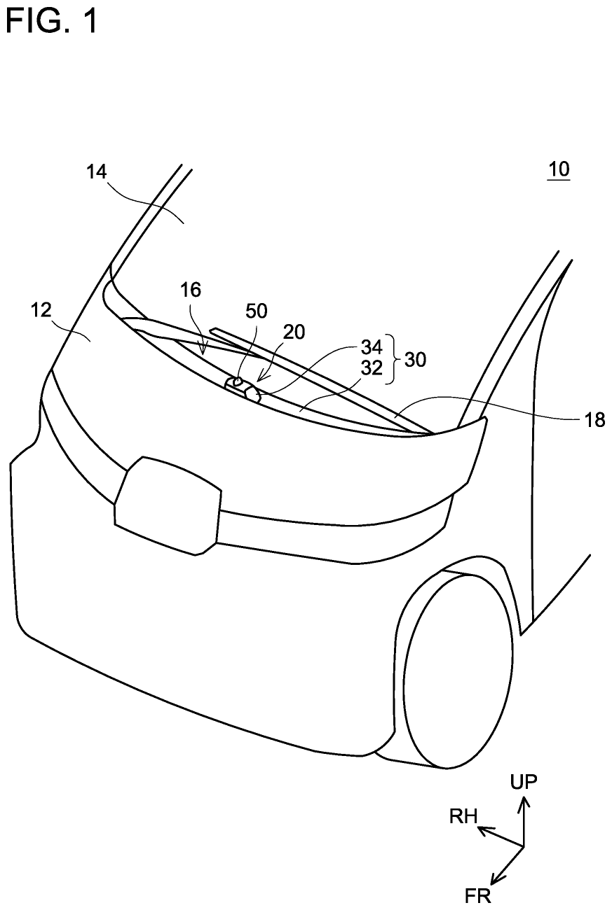

FIG. 1 shows a front portion of a vehicle 10. A nozzle unit 20 according to an embodiment is mounted on the front portion of the vehicle 10. The nozzle unit 20 includes a cowl top panel 30 and a washer nozzle 50. The cowl top panel 30 is constituted of resin and covers a cowl portion 16 which is a portion between a hood 12 and a windshield 14 of the vehicle 10. The cowl top panel 30 is also called a cowl louver. The cowl top panel 30 includes a cover 32 and a boss 34. The cover 32 covers the cowl portion 16. The boss 34 is disposed at the center of the cover 32. The boss 34 protrudes upward from an upper surface of the cover 32. The washer nozzle 50 is disposed on an upper surface of the boss 34. The washer nozzle 50 protrudes upward from the upper surface of the boss 34. A rotational axis of a windshield wiper 18 is on the cover 32. When the windshield wiper 18 is not in operation, it is on the windshield 14 along the cowl portion 16. When the windshield wiper 18 is not in operation, it is positioned rearward of the boss 34 (i.e., the washer nozzle 50). The washer nozzle 50 sprays washer fluid to the windshield 14. Since the washer nozzle 50 is disposed on the boss 34, it is positioned at a higher position relative to the cover 32. Therefore, the washer fluid sprayed from the washer nozzle 50 reaches the windshield 14 beyond the windshield wiper 18. As above, the washer nozzle 50 being disposed on the boss 34 facilitates the washer fluid sprayed from the washer nozzle 50 to pass beyond the windshield wiper 18. Thus, even when spacing between the washer nozzle 50 and the windshield wiper 18 (spacing in a longitudinal direction of the vehicle) is narrow, the washer fluid can reach the windshield 14.

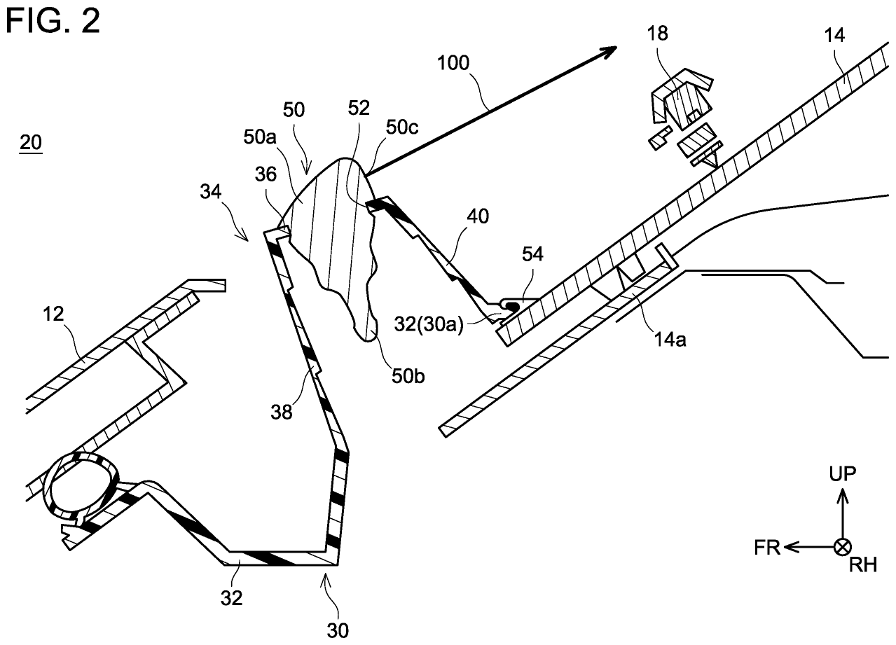

FIG. 2 shows a longitudinal cross-sectional view of the nozzle unit 20 at the center in a width direction of the vehicle 10. As shown in FIG. 2, the boss 34 protruding upward from the cover 32 is formed in the cowl top panel 30 by the cowl top panel 30 bending. The boss 34 extends upward beyond the hood 12. The boss 34 includes an upper plate 36, a front side plate 38 extending downward from a front end of the upper plate 36, and a rear side plate 40 extending downward from a rear end of the upper plate 36. A portion of the cowl top panel 30 rearward of the rear side plate 40 (a rear end portion 30a of the cowl top panel 30) extends along the windshield 14. The rear end portion 30a is in contact with an upper surface of the windshield 14. The joint area of the rear end portion 30a and the windshield 14 is sealed by a sealing material 54. The cowl top panel 30 is fixed, at a position which is not shown, to a window frame 14a supporting the windshield 14. A portion of the cowl top panel 30 frontward of the front side plate 38 extends below the hood 12. The cowl top panel 30 is fixed to a metal member constituting the body of the vehicle 10 at a position frontward of the front side plate 38 (at a position below the hood 12), although this is not shown.

The upper plate 36 is provided with a through hole 52 that penetrates the upper plate 36 in a vertical direction. The washer nozzle 50 is inserted in the through hole 52 and is fixed to the upper plate 36 in the inserted state. An upper portion 50a of the washer nozzle 50 protrudes upward from an upper surface of the upper plate 36. A lower portion 50b of the washer nozzle 50 is positioned below the upper plate 36 (i.e., inside the boss 34). The upper portion 50a is provided with a spray spout 50c from which the washer fluid is sprayed. The spray spout 50c is directed toward the windshield 14. A washer fluid supply tube through which the washer fluid is supplied to the washer nozzle 50 is connected to the lower portion 50b of the washer nozzle 50, although this is not shown. As indicated by an arrow 100, the washer nozzle 50 sprays the washer fluid supplied from the washer fluid supply tube to the windshield 14 from the spray spout 50c.

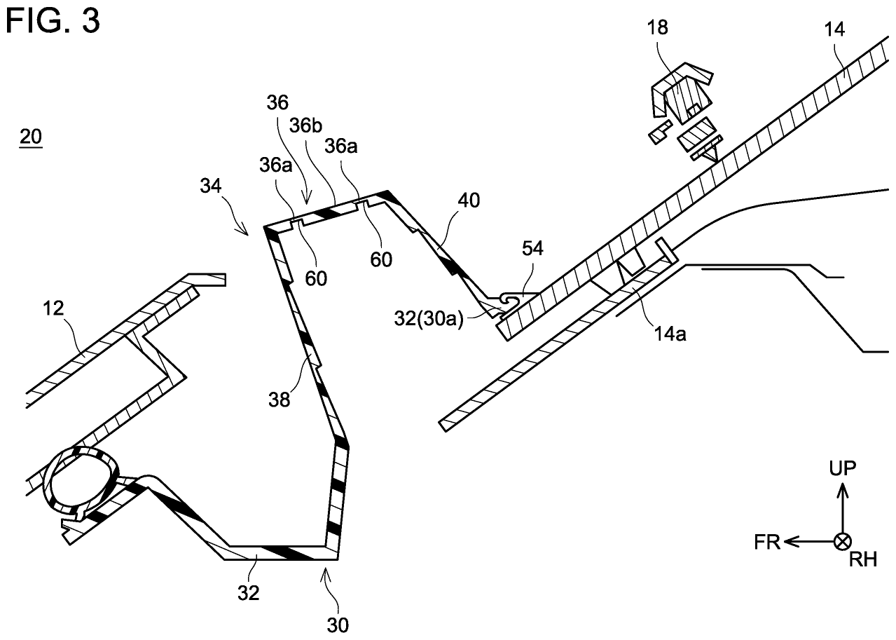

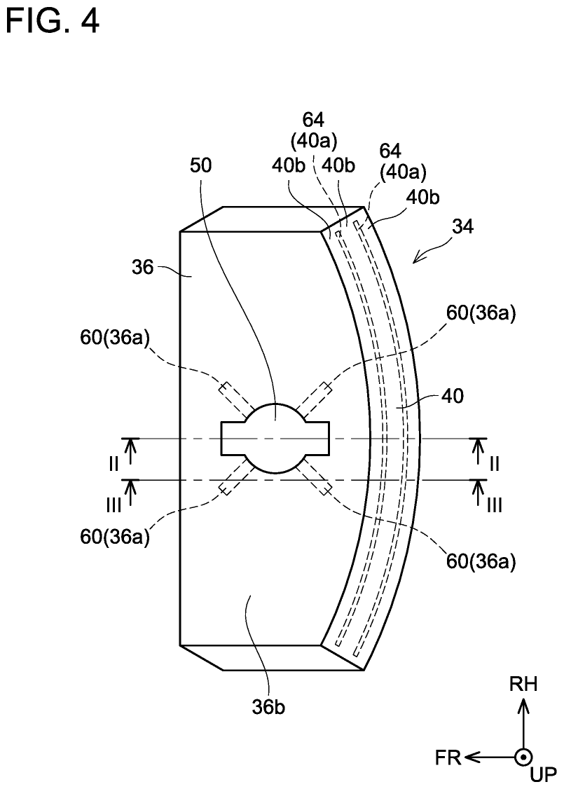

FIG. 3 shows a cross-sectional view of the boss 34 along a line that does not cross the washer nozzle 50. As shown in FIG. 3, a plurality of grooves 60 is provided in a lower surface of the upper plate 36 of the boss 34. The upper surface of the upper plate 36 of the boss 34 is flat. Thus, the thickness of the upper plate 36 is thinner at areas where the grooves 60 are provided. Hereinbelow, the areas of the upper plate 36 where the grooves 60 are provided will be termed thin portions 36a, and an area of the upper plate 36 where no grooves 60 are provided will be termed a thick portion 36b. The thin portions 36a each have a smaller thickness than a thickness of the thick portion 36b. As shown in FIG. 4, four grooves 60 are provided in the upper plate 36. The four grooves 60 radially extend outward from the washer nozzle 50. That is, the upper plate 36 is provided with four thin portions 36a and the four thin portions 36a radially extend outward from the washer nozzle 50. The thick portion 36b corresponds to a remaining portion of the upper plate 36 from which the four thin portions 36a are excluded. The thick portion 36b surrounds the thin portions 36a.

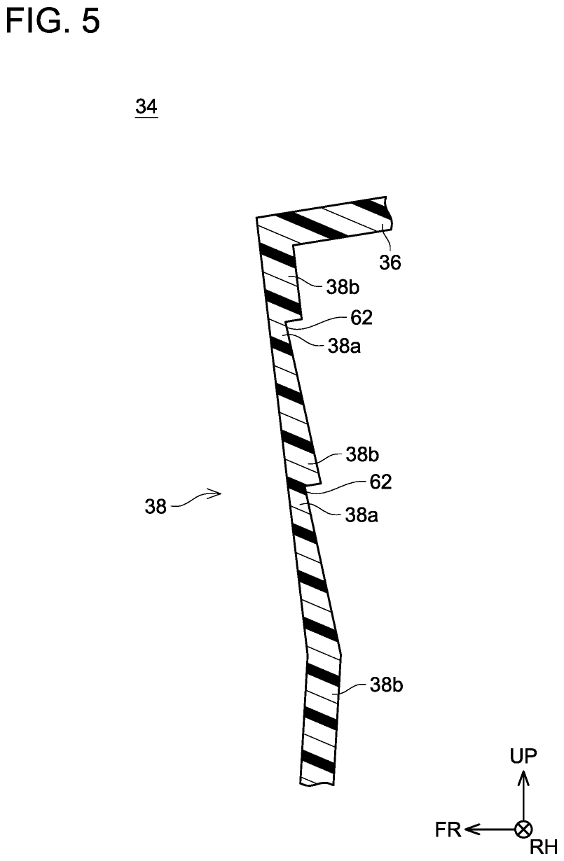

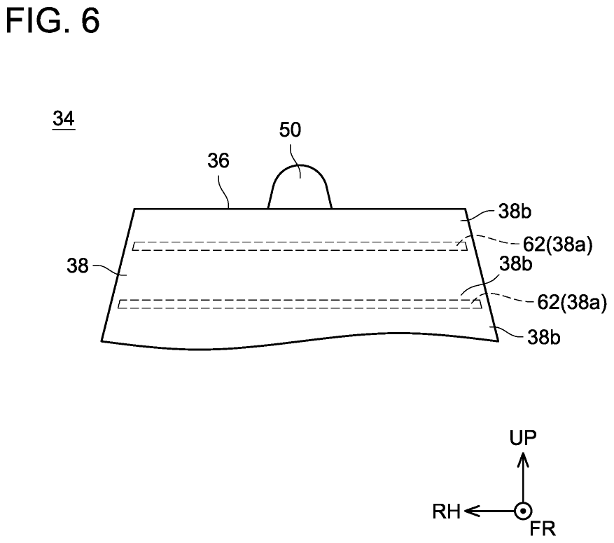

As shown in FIG. 5, a plurality of grooves 62 is provided in an inner surface (a surface facing the inside of the boss 34) of the front side plate 38 of the boss 34. An outer surface (a surface facing the outside of the boss 34) of the front side plate 38 is flat. Thus, the thickness of the front side plate 38 is thinner at areas where the grooves 62 are provided. Hereinbelow, the areas of the front side plate 38 where the grooves 62 are provided will be termed thin portions 38a, and areas of the front side plate 38 where no grooves 62 are provided will be termed thick portions 38b. The thin portions 38a each have a smaller thickness than the thickness of the thick portions 38b. The grooves 62 (i.e., the thin portions 38a) are arranged at intervals along the vertical direction. As shown in FIG. 6, the grooves 62 (i.e., the thin portions 38a) extend linearly along the width direction of the vehicle (horizontal direction). As shown in FIG. 5, the thickness of the front side plate 38 gradually decreases from each thick portion 38b to the thin portion 38a positioned thereabove. That is, the thickness of the front side plate 38 continuously decreases from each thick portion 38b to the thin portion 38a positioned thereabove. The thickness of the front side plate 38 varies in a stepped manner between each thick portion 38b and the thin portion 38a positioned therebelow.

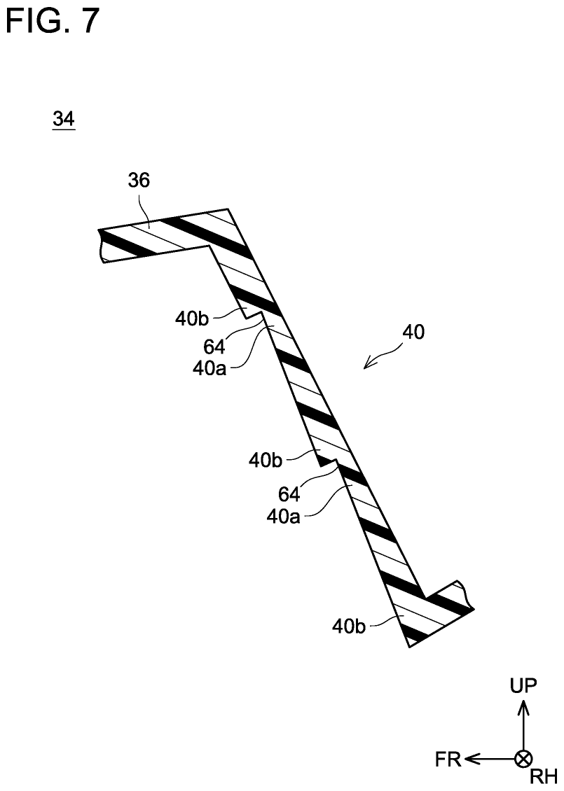

As with the front side plate 38, as shown in FIG. 7, grooves 64 are provided in an inner surface (a surface facing the inside of the boss 34) of the rear side plate 40. An outer surface (a surface facing the outside of the boss 34) of the rear side plate 40 is flat. Thus, the thickness of the rear side plate 40 is thinner at areas where the grooves 64 are provided. Hereinbelow, the areas of the rear side plate 40 where the grooves 64 are provided will be termed thin portions 40a, and areas of the rear side plate 40 where no grooves 64 are provided will be termed thick portions 40b. The thin portions 40a each have a smaller thickness than the thickness of the thick portions 40b. The grooves 64 (i.e., the thin portions 40a) are arranged at intervals along the vertical direction. As shown in FIG. 4, the grooves 64 (i.e., the thin portions 40a) extend linearly along the width direction of the vehicle (horizontal direction). As shown in FIG. 7, the thickness of the rear side plate 40 gradually decreases from each thick portion 40b to the thin portion 40a positioned thereabove. That is, the thickness of the rear side plate 40 continuously decreases from each thick portion 40b to the thin portion 40a positioned thereabove. The thickness of the rear side plate 40 varies in a stepped manner between each thick portion 40b and the thin portion 40a positioned therebelow.

When the front portion of the vehicle 10 collides with a pedestrian, the washer nozzle 50 may collide with the pedestrian (e.g., his/her head). In particular, the washer nozzle 50 is highly likely to collide with the pedestrian since the boss 34 is not covered by the hood 12. When the washer nozzle 50 collides with the pedestrian, a downward force is applied to the washer nozzle 50. When the downward force is applied to the washer nozzle 50, the thin portions 36a provided at the upper plate 36 of the boss 34 bend or fracture, thereby causing the washer nozzle 50 to bury into the upper plate 36. In particular, the thin portions 36a radially extending outward from the washer nozzle 50 facilitates the washer nozzle 50 to bury into the upper plate 36. The impact applied from the washer nozzle 50 to the pedestrian can be reduced by the washer nozzle 50 being buried as above.

Further, when the washer nozzle 50 collides with the pedestrian, a downward force is applied to the boss 34. Under the force, the thin portions 38a of the front side plate 38 and the thin portions 40a of the rear side plate 40 bend or fracture, thereby causing the boss 34 to collapse. The impact applied from the washer nozzle 50 to the pedestrian can be reduced also by the boss 34 being collapsed as above. In particular, since the thin portions 38a, 40a are arranged at intervals along the vertical direction at the front side plate 38 and the rear side plate 40, this facilitates the front side plate 38 and the rear side plate 40 to bend at different positions. Further, since the thin portions 38a extend linearly along the horizontal direction, the thin portions 38a, 40a are facilitated to bend or fracture. Therefore, the impact is likely to be absorbed when the boss 34 collapse, efficiently reducing the impact applied to the pedestrian. Further, as described, in each of the front side plate 38 and the rear side plate 40, the thickness continuously decreases from each thick portion to the thin portion positioned thereabove. Areas with the continuously decreased thickness is likely to flexibly bend when the boss 34 collapses. The impact is likely to be absorbed also by the areas with the continuously decreased thickness, efficiently reducing the impact applied to the pedestrian.

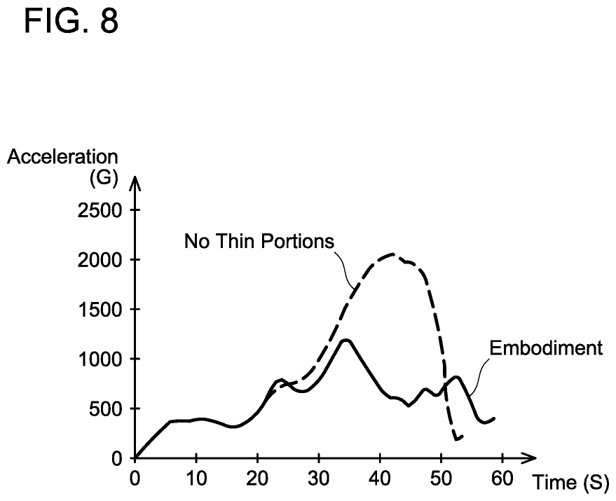

As above, the nozzle unit 20 according to the embodiment can efficiently reduce the impact applied to the pedestrian from the washer nozzle 50 upon a collision. FIG. 8 shows changes in acceleration applied to a collision site of a pedestrian dummy when the washer nozzle 50 collides with the dummy. As shown, the embodiment provided with the thin portions 36a, 38a, and 40a can reduce the acceleration applied to the dummy compared with a case provided with none of those portions.

Further, as described, in each of the front side plate 38 and the rear side plate 40, the thickness continuously decreases from each thick portion to the thin portion positioned thereabove. In injection-molding of the cowl top panel 30, this configuration facilitates a mold for forming the inner surface of the boss 34 to be pulled out from the inside of the boss 34. Thus, it facilitates the manufacturing of the cowl top panel 30.

If grooves are provided in the outer surface of the boss 34, foreign matter is likely to accumulate in the grooves because the outer surface of the boss 34 is weathered. To the contrary, in the nozzle unit 20 according to the embodiment, the thin portions 36a, 38a, and 40a are formed by the grooves 60, 62, and 64 being formed in the inner surface of the boss 34. Therefore, foreign matter is less likely to adhere to the outer surface of the boss 34, and thus the outer appearance of the boss 34 is less likely to get dirty.

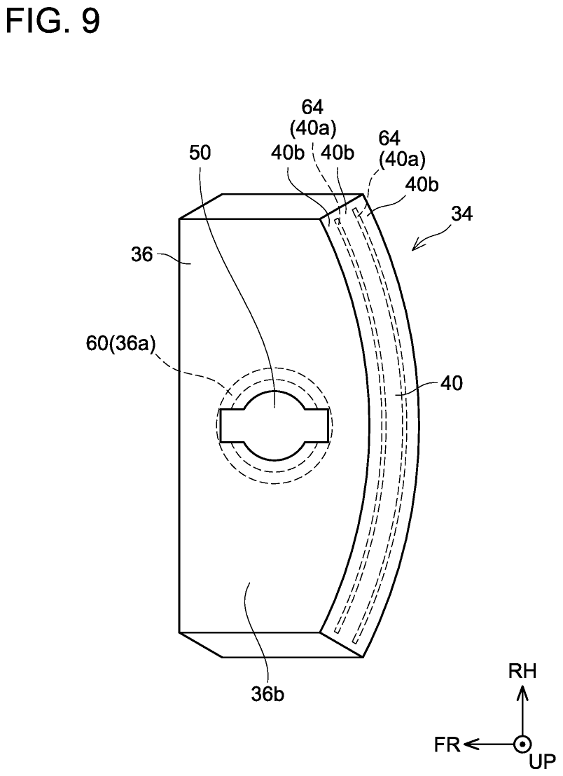

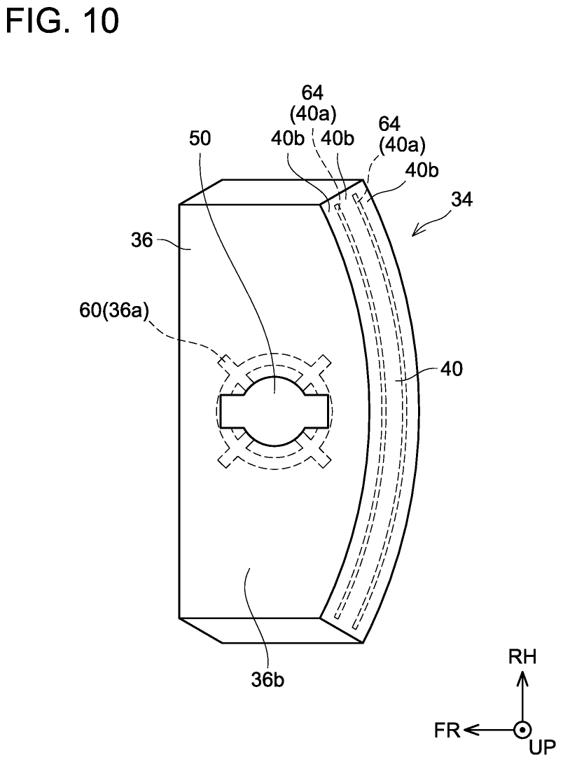

In the above-described embodiment, the thin portions 36a (i.e., the grooves 60) radially extend from the washer nozzle 50 in the upper plate 36 of the boss 34. However, as shown in FIG. 9, the thin portion 36a (i.e., the groove 60) may extend in a loop shape to surround the washer nozzle 50. The thin portion 36a (i.e., the groove 60) may extend in a circular loop shape as shown in FIG. 9, may extend in a rectangular loop shape, or may extend in a loop shape of another geometry. Further, multiple thin portions 36a (i.e., grooves 60) may each extend to circle the washer nozzle 50. Further, as shown in FIG. 10, the thin portion 36a (i.e., the groove 60) may have a shape of combination of radial and loop patterns. Even with the thin portion(s) 36a (i.e., the groove(s) 60) having any of the above shapes, the washer nozzle 50 can be buried upon a collision.

In the above-described embodiment, the thin portions 38a (i.e., the grooves 62) extend linearly along the width direction of the vehicle. However, the thin portions 38a (i.e., the grooves 62) may extend in a curved manner or in a zigzag manner along the width direction of the vehicle. Even with any of these configurations, the thin portions 38a can be bent or fractured upon a collision. However, in the configuration where the thin portions 38a (i.e., the grooves 62) extend linearly along the width direction of the vehicle, the thin portions 38a can be bent or fractured more easily upon a collision.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A nozzle unit configured to spray washer fluid to a windshield of a vehicle, the nozzle unit comprising:
a base plate; and
a washer nozzle protruding upward from an upper surface of the base plate,
wherein the base plate comprises:
a thin portion provided around the washer nozzle; and
a thick portion provided around the thin portion and having a thickness greater than a thickness of the thin portion.

2. The nozzle unit of claim 1, wherein the thin portion comprises a plurality of line portions extending radially from the washer nozzle.

3. The nozzle unit of claim 1, wherein the thin portion comprises a loop portion surrounding the washer nozzle.

4. The nozzle unit of claim 1, wherein a groove is provided in a lower surface of the base plate within the thin portion.

5. The nozzle unit of claim 1, further comprising:
a cover covering a cowl portion which is a portion between a hood of the vehicle and the windshield; and
a boss protruding upward from an upper surface of the cover,
wherein
the boss comprises:
an upper plate including an upper surface of the boss; and
a side plate extending downward from the upper plate, and
the base plate is the upper plate.

6. The nozzle unit of claim 5, wherein the side plate comprises:
a thin portion extending along a width direction of the vehicle; and
a thick portion adjoining the thin portion of the side plate and having a thickness greater than a thickness of the thin portion of the side plate.

7. The nozzle unit of claim 6, wherein the thin portion of the side plate extends linearly along the width direction.

8. The nozzle unit of claim 7, wherein the thin portion of the side plate comprises a plurality of thin portions arranged at intervals along a vertical direction.

9. The nozzle unit of claim 6, wherein a groove is provided in an inner surface of the side plate within the thin portion of the side plate.

10. The nozzle unit of claim 6, wherein a thickness of the side plate continuously decreases from the thick portion of the side plate to the thin portion of the side plate.
